(19) United States
(12) Patent Application Publication
(10) Pub. No.: US 2006/0119147 A1
(43) Pub. Date: Jun. 8, 2006

(54) Bicycle seat

(76) Inventor: Paul Damian Nelson, South Yarra (AU)

Correspondence Address: NEEDLE & ROSENBERG, P.C., SUITE 1000, 999 PEACHTREE STREET, ATLANTA, GA, 30309-3915, US

(21) Appl. No.: 11/335,272

(22) Filed: Jan. 19, 2006

Related U.S. Application Data
(63) Continuation of application No. 11/076,082, filed on Mar. 9, 2005, now abandoned.
Application No. 11/076,082 is a continuation of application No. 10/343,043, filed on Jun. 9, 2003, now abandoned.

(30) Foreign Application Priority Data
Jul. 28, 2002 (AU) PQ9067

(51) Int. Cl. B62J 1/00

(52) U.S. Cl. 297/195.1

(57) ABSTRACT

A bicycle seat is disclosed which includes a shell (12) to which a mounting rail (16) is attached. The mounting rail (16) is connected by a mounting plate for securing one end of the rail and amounting hole for securing the other end of the rail. The mounting plate and securing hole allow the shell (12) to rock relative to the rail (16) in a plane substantially perpendicular to the axis of the shell (12). The shell (12) also has a rib structure to reinforce the shell.

### This invention relates to a bicycle seat.

Bicycle seats generally comprise a shell which has a nose portion and a pair of buttock receiving portions. Generally the shell is formed from polymer material and upholstery is applied in order to soften the shell. During the course of pedaling a bicycle, the seat generally remains in a rigid condition and does not spring. This resists the normal muscular movement of a persons anatomy during the course of pedaling while the rider sits on the bicycle seat.

Many techniques are known for suspending a bicycle seat including spring suspension systems and the like. However, these merely provide suspension to a portion or the entire shell, relative to the bicycle.

The object of the present invention is to provide further improvements to a bicycle seat with a view to enabling the seat to move with bodily movement of a rider during pedaling of bicycle.

The invention may be said to reside in a bicycle seat including;
a shell having a seat portion for enabling a user to sit on the seat and pedal a bicycle;
a mounting means for mounting the seat to a bicycle; and
securing means for securing the mounting means to the shell to allow the shell to rock relative to the mounting means in a plane substantially perpendicular to the longitudinal axis of the bicycle when the seat is mounted on the bicycle.

The invention may also be said to reside in a bicycle seat including;
a shell having a front nose portion and rear seat portion, the shell having a longitudinal axis through the nose portion and the seat portion;
a mounting rail for mounting the seat to a bicycle;
first securing means for securing the rail to the seat portion of the shell substantially on the longitudinal axis of the shell;
second securing means for securing the rail to the nose portion of the shell substantially on the longitudinal axis of the shell; and
wherein the first securing means allows the shell to rock relative to the rail in a plain substantially perpendicular to the axis of the shell.

According to the above aspect of the invention, the securing means which enables the rocking motion to take place, allows the seat to rock or pivot in the perpendicular plane relative to the rail during pedaling of a bicycle to facilitate pedaling motion and reduce unresisted reaction against a users buttocks during the pedaling motion. Thus, during pedaling the bicycle seat is able to pivot generally around the longitudinal axis in the perpendicular plane. This movement therefore provides some relief to the reaction of the bicycle seat during the pedaling motion and reduces muscle fatigue and soreness which usually occurs during prolonged pedaling.

The degree to which the entire seat rocks depends on the flexibility of the shell. If the shell is rigid the entire seat will rock. However if the shell has some flexibility one portion could rock or move to some extent independently of other portions.

Preferably the first securing means includes a mounting plate for sandwiching a portion of the rail between the plate and the shell.

Preferably the first securing mean further includes a rivet for passing through an opening in the plate and into a hole in the shell.

Preferably the shell has rail support elements which define a channel for receiving said portion of the rail.

In one embodiment of the invention the mounting plate has a rail receiving portion which is substantially flat, and said portion to the rail is substantially straight, the said receiving portion being relatively short in a direction transverse to the longitudinal axis of the shell to facilitate said rocking movement.

In another embodiment of the invention the mounting plate has a rail receiving portion which is curved to define a curved pivot surface, said portion of said rail also being curved in a manner corresponding to the curvature of the mounting plate, the curved portion of the rail providing a curved surface on which the shell can easily rock or pivot to facilitate said rocking movement.

Preferably said second securing means comprises at least one hole in said shell into which a second portion of said rail projects.

In one embodiment a single hole is provided which has a longitudinal axis coincident with the longitudinal axis of the shell, said second portion of the rail being comprised by two legs of the rail which are adjacent one another and which insert into said hole.

In another embodiment two holes are provided in the shell, the holes being adjacent the longitudinal axis of the shell with one hole on each side of the axis, the rail having two legs which are spaced apart from one another which form said second portion of the rail, the legs of the rail being inserted into said holes.

In another embodiment a resilient member is disposed between the securing means and the shell.

The resilient member can facilitate the rocking movement of the shell or, alternatively, dampen or otherwise modify the rocking movement of the shell relative to the mounting means.

In one preferred embodiment the resilient member is located between the shell and/or the first securing means and the mounting rail. The resilient member may include a pad or, alternatively, a sleeve which surrounds the mounting rail at the position of the mounting rail where the first securing means secures the mounting rail to the shell. In other embodiments the resilient means may be provided between the securing means and the shell adjacent the mounting rail.

In one embodiment of the invention the leg or legs of the mounting rail may have a resilient member which is located between the legs and a side wall of the hole or holes so as to facilitate and/or dampen movement of the legs of the rail relative to the shell.

In one embodiment of the invention the securing means may comprise a pair of spaced apart sockets formed in the shell for receiving free ends of the rail at a rear portion of the rail.

In one embodiment of the sockets may include resilient pads for facilitating rocking movement of the shell relative to the free ends of the rail.

In one embodiment the security means rigidly attaches the shell to the rail and rocking movement is accommodated by flexure of the shell.

In a further aspect the invention may be said to reside in a bicycle seat including;
a shell having a seat portion on which a user can sit to pedal a bicycle;
a mounting means for mounting the seat to a bicycle;
a resilient member disposed between the mounting means and the shell for facilitating rocking movement of the shell relative to the mounting means in a plane substantially perpendicular to the longitudinal axis of a bicycle when the seat is mounted on the bicycle.

In a further aspect the invention may be said to reside in a mounting rail for a bicycle seat, including;
a pair of separate legs which are arranged adjacent one another for receipt in a cavity of a front portion of a bicycle seat;
each leg being integrally coupled to a mounting rail portion for connecting the mounting rail to a bicycle by way of a clamp; and
an engaging portion for engaging a securing means to secure the engaging portion to a portion of the seat rearward of the cavity.

Preferably, the engaging portion is an integral portion of the rail which joins the clamping portions of the rails.

The invention in a further aspect may be said to reside in a bicycle seat, including;
a shell having an upper surface upon which a user can sit to peddle a bicycle;
an underneath surface; and
a rib structure on the underneath surface to reinforce the shell so that the shell can support the weight of a user.

This aspect of the invention has the advantage of enabling the bicycle seat to be secured to a bicycle by securing points which are arranged substantially on and along the longitudinal axis of the seat. Thus, the seat is not supported other than on the longitudinal. The rib structure thereby reinforces the seat so that the unsupported parts of the seat which are those parts laterally of the location where the seat is secured, are sufficiently strong to take the weight of a rider during pedalling of a bicycle.

Preferably, the rib structure includes;
a first curved rib;
a second curved rib spaced from the first curved rib;
the first and second curved ribs being generally symmetrical about a longitudinal axis of the bicycle seat; and
a plurality of laterally extending ribs which extend between the first and second curved ribs.

Preferably the bicycle seat includes a slot in a rear portion of the seat and the slot includes a wall portion which extends downwardly from the bottom surface of the shell, the lateral ribs extending to and joining the said wall.

Preferably a third curved rib is provided, the third curved rib being spaced from the second curved rib and the lateral ribs joining the first rib, the second curved rib and the third curved rib.

Preferably a boss is formed between the first curved rib and the second curved rib, the boss having a hole for receiving a mounting fixture for facilitating mounting of rail to the shell, the boss having an end wall, a plurality of curved webs extending between the end wall and the first curved rib which, with the end wall and the first curved rib define a channel for receiving a part of the mounting rail, and wherein further lateral ribs extend from the bos and connect with the second curved rib.

Preferably, the rib structure allows the shell to spring or flex.

A further aspect of the invention may be said to reside in a bicycle seat including;
a shell having an upper surface upon which a user sits to pedal a bicycle;
an underneath surface;
a rib structure formed on the underneath surface, the rib structure including;
a first curved rib;
a second curved rib spaced from the second curves rib; and
a plurality of lateral ribs interconnecting the first and second curved ribs.

Preferably the bicycle seat includes a slot in a rear portion of the seat and the slot includes a wall portion which extends downwardly from the bottom surface of the shell, the lateral ribs extending to and joining the said wall.

Preferably a third curved rib is provided, the third curved rib being spaced from the second curved rib and the lateral ribs joining the first rib, the second curved rib and the third curved rib.

Preferably a boss is formed between the first curved rib and the second curved rib, the boss having a hole for receiving a mounting fixture for facilitating mounting of rail to the shell, the boss having an end wall, a plurality of curved webs extending between the end wall and the first curved rib which, with the end wall and the first curved rib define a channel for receiving a part of the mounting rail, and wherein further lateral ribs extend from the bos and connect with the second curved rib.

A preferred embodiment of the invention will be described, by way of example, with reference to the accompanying drawings in which;

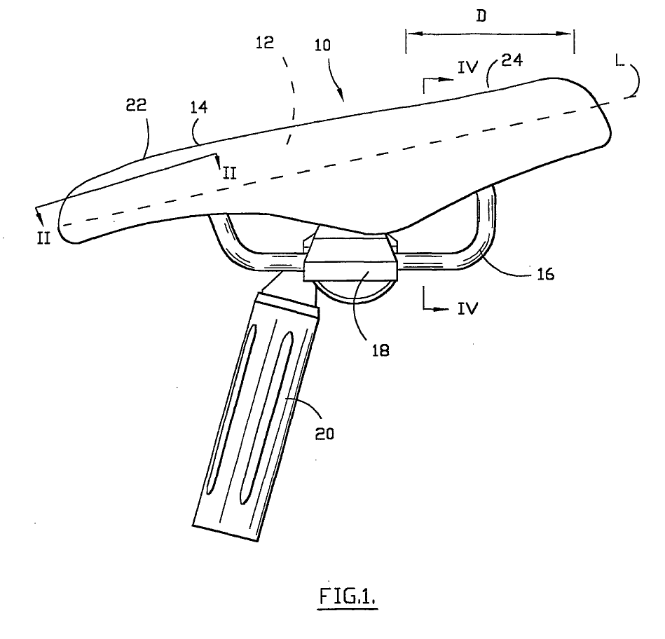

FIG. 1 is a side view of a bicycle seat embodying the invention;

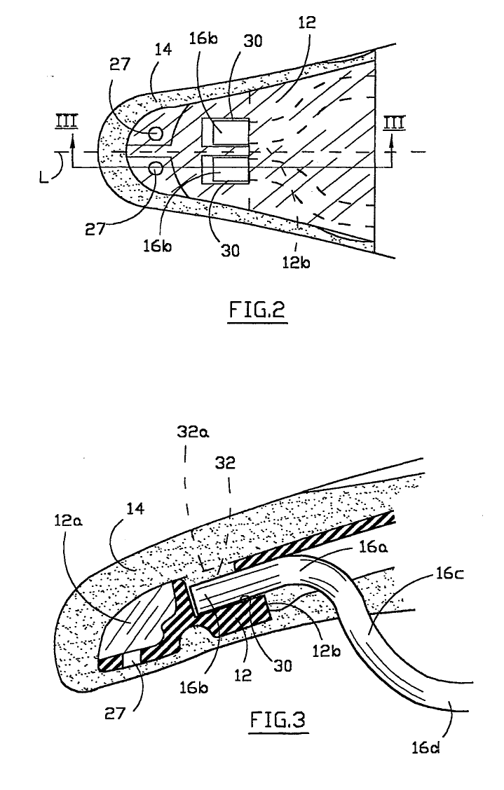

FIG. 2 is a cross-sectional view along the line II-II of FIG. 1;

FIG. 3 is a cross-sectional view along the line III-III of FIG. 2;

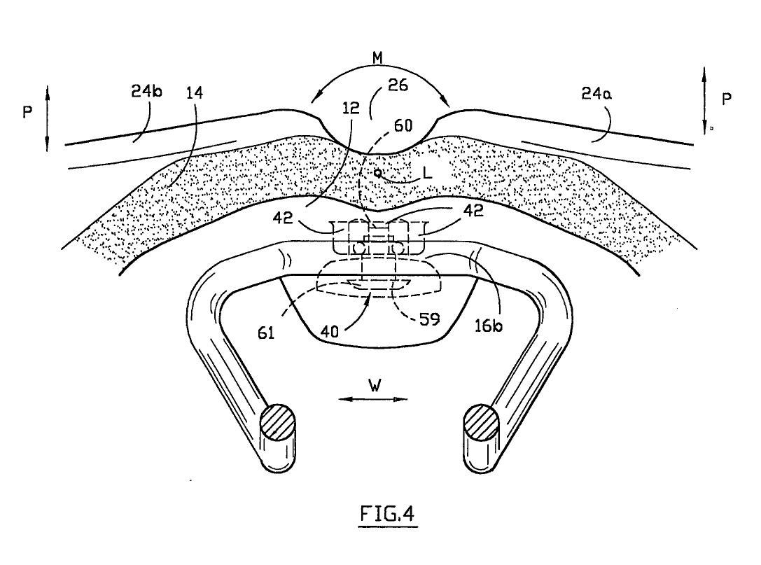

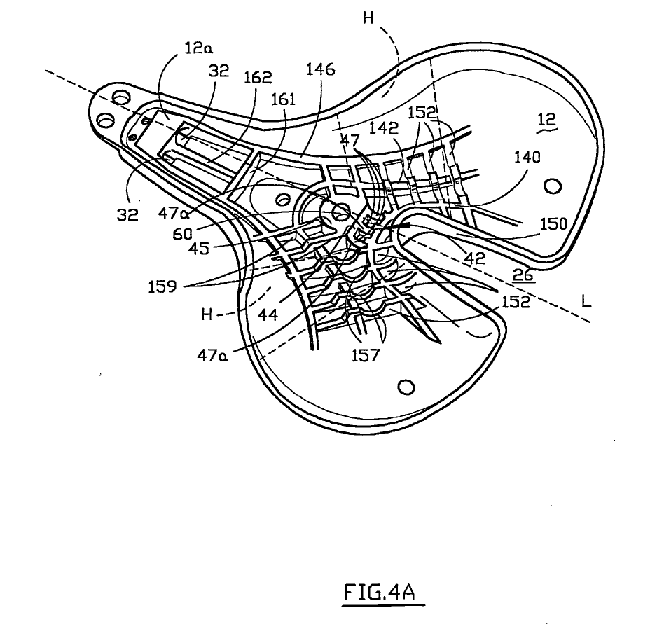

FIG. 4 is a cross-sectional view along the line IV-IV of FIG. 1;

FIG. 4A is an underneath view of a bicycle seat shell used in the embodiment of FIG. 1;

FIG. 5 is a view of the seat embodying the invention looking up from beneath the seat;

FIG. 6 is a perspective view of a mounting rail according to one embodiment of the invention;

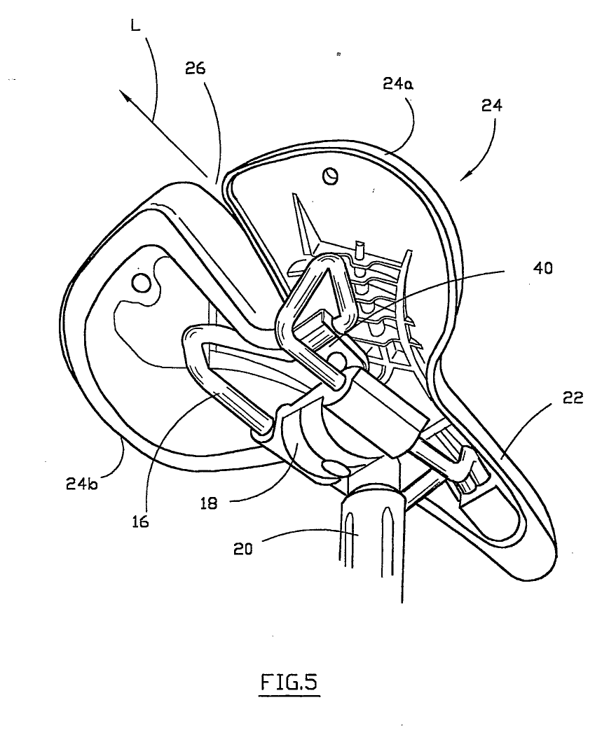

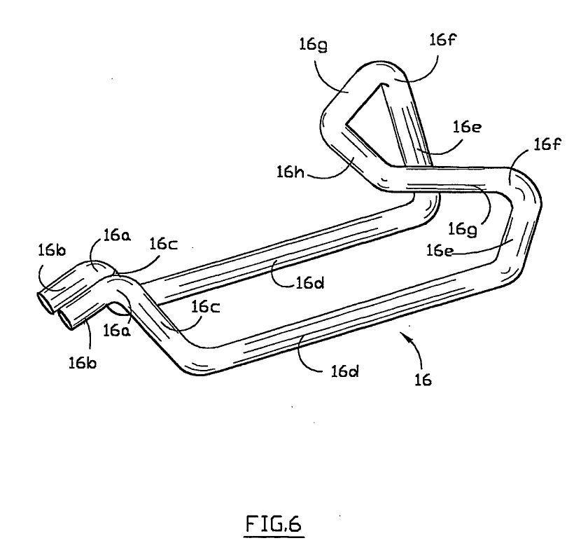

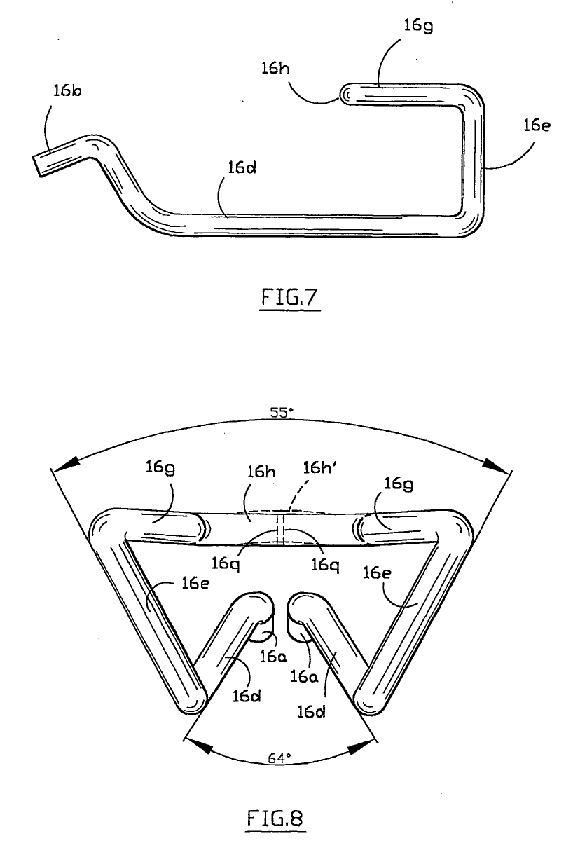

FIG. 7 is a side view of the mounting rail of FIG. 6;

FIG. 8 is a end view of the mounting rail of FIG. 6;

FIG. 9 is a plan view of the mounting rail of FIG. 6;

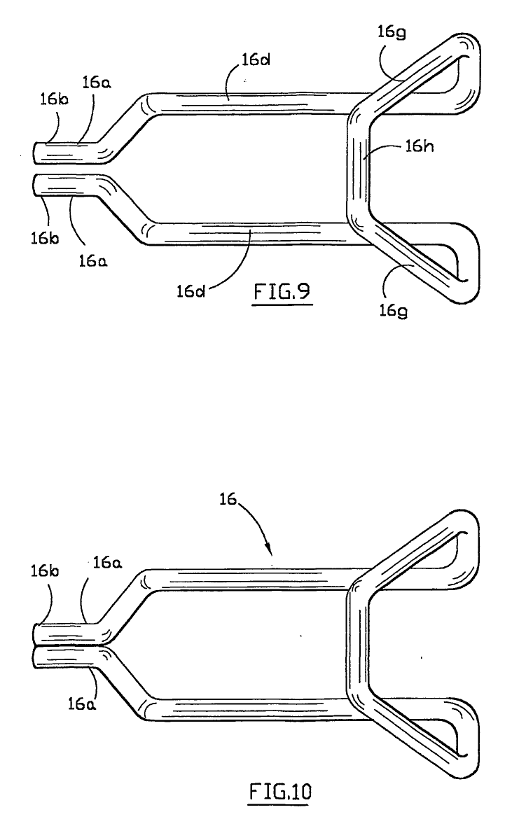

FIG. 10 is a plan view of a mounting rail according to a second embodiment;

FIG. 11 is an underneath view of a mounting plate used in the preferred embodiment of the invention;

FIG. 11A is a view of the mounting plate of FIG. 11 from above;

FIG. 12 is a view similar to FIG. 4 but of a second embodiment of the invention;

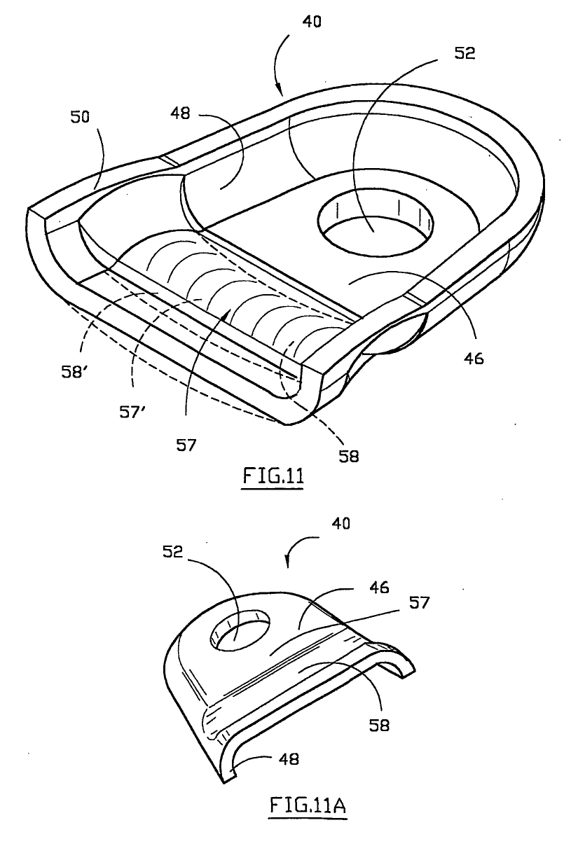

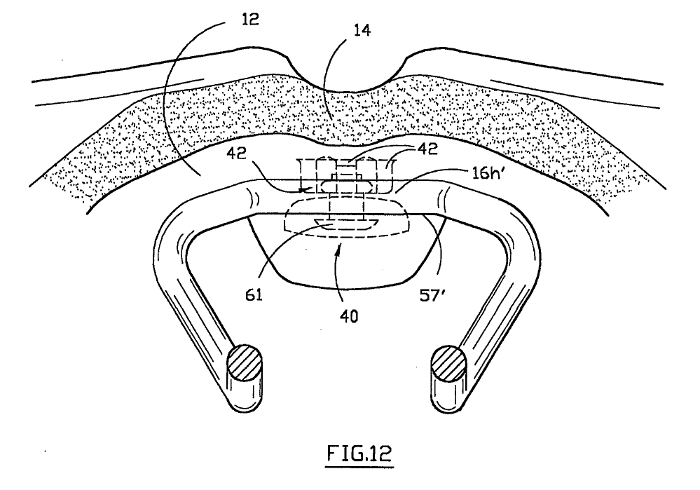

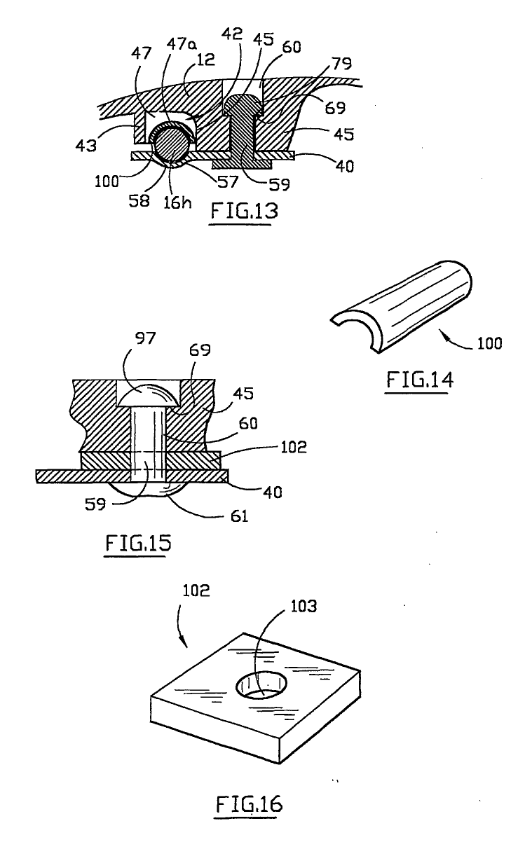

FIG. 13 is a cross-sectional view through a securing portion showing a further embodiment of the invention;

FIG. 14 is a view of a mounting pad used in the embodiment of FIG. 13;

FIG. 15 is a view of a mounting portion of the seat showing a further embodiment of the invention;

FIG. 16 is a view of a mounting pad used in the embodiment of FIG. 15;

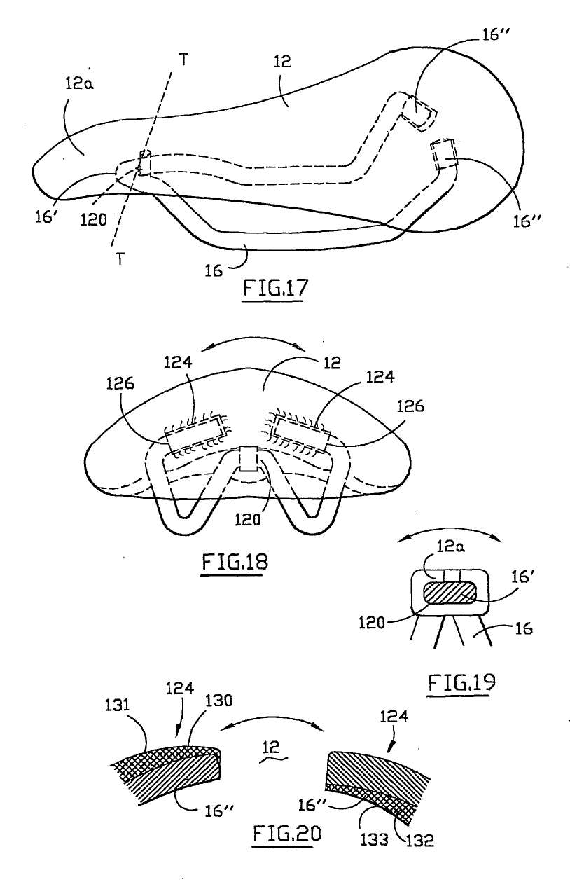

FIG. 17 is a view of a further embodiment of the invention;

FIG. 18 is an end view of the embodiment of FIG. 17;

FIG. 19 is a cross-sectional view along the line TT of FIG. 17; and

FIG. 20 is a more detailed view showing part of the structure of FIG. 18.

With reference to FIG. 1 a bicycle seat 10 is shown which has a unitary shell structure 12 formed from plastics or like material which may be covered by an upholstery member 14. The upholstery member 14 may be moulded onto the shell in a moulding operation or may be applied in any suitable fashion.

The seat 10 has a mounting rail 16 which enables mounting of the seat to a bicycle (not shown). In order to mount the rail 16 to the bicycle a clamp 18 engages the rail 16 and the clamp 18 is connected to a post 20 which is received in a sleeve or socket (not shown) of a frame (not shown) of the bicycle. The clamp 18 and post 20 operate is a manner known per se and therefore will not be described in any further detail.

The bicycle seat 10 has a nose portion 22 and a seat portion 24.

As best shown in FIG. 5 the seat portion 24 may be former in two parts 24a and 24b which are divided by a slot 26 where each of the portions 24a and 24b receive one of the riders buttocks with the crouch area of the rider straddling the nose portion 22.

As shown in FIGS. 1 and 5 the seat 10 has a longitudinal axis L which extends lengthwise of the seat through the nose portion 22 and through the seat portion 24 symmetrically between the portions 24a and 24b.

The shell 12 of the seat 10 may be formed in accordance with the teachings of our International application PCT/AU97/00818. The contents of that specification are incorporated into this specification by this reference. In the earlier International application, the shell 22 is a unitary structure with a hinge section between the portion 24a and 24b and the nose 22 to facilitate independent movement of the portions 24a and 24b during pedaling motion. However, according to this invention, it is possible that the shell 22 be formed from rigid material without the ability of the portions 24a and 24b to move in the manner described in our earlier International application.

The shell 12 may be provided with holes 27 (see FIGS. 2 and 3) which facilitate moulding of the shell and also connection of the upholstery portion 14 to the shell 12 during a moulding operation.

The shell 12 has a generally solid nose portion 12a which has two holes 30 formed into an end wall portion 12b of the nose portion 12a. The holes 30 have an upper opening in which an upper surface of the shell 12 as best seen in FIG. 3 to facilitate formation of the holes 30 by tooling during the moulding operation. The bores 32 generally taper downwardly from a wide entrance portion adjacent the upper surface of the shell 12 as shown by reference 32 in FIG. 3 to intersect the holes 30. The holes 30 are preferably of cylindrical configuration.

The mounting rail 16 is best shown in FIGS. 6 to 9. With reference to those Figures, the mounting rail 16 has a pair of legs 16a which have ends 16b. The legs 16a merge downwardly and outwardly via transition sections 16c to clamp support rail portions 16d. The clamp support sections 16d then taper upwardly and outwardly at portions 16e and have a curved transition section 16f which join with inwardly projecting portions 16g. The inwardly projecting portions 16g are joined by an engagement portion 16h.

Returning to FIGS. 2 and 3, the end portion 16b of the mounting rail 16 are received within the holes 30 as clearly seen in FIGS. 2 and 3. This secures the rail 16 to the nose portion of 12a of the shell 12 and therefore to the nose portion 22 of the seat 10.

As best shown in FIGS. 4, the mounting rail 16 is secures to the seat portion of the seat 10 by sandwiching the engagement portion 16h of the rail between the shell 12 and a mounting plate 40 shown in more detail in FIGS. 11 and 11A.

Preferably the point of securement is about in the central portion of the seat as best seen in FIG. 5. Most preferably this location is at least 5 cm from a rear most portion of the seat as shown by arrow D in FIG. 1.

As best seen in FIG. 4A the shell 12 is provided with a channel for receiving engagement portion 16h of the rail 16 and locating the rail in place relative to the shell 12.

The channel 42 is defined by an arcuate rib 140 which form one of a plurality of strengthening ribs shown in FIG. 4 which strengthen the bicycle seat and also facilitate movement of the bicycle seat according to the embodiment of the invention disclosed in the aforementioned International application. The channel 42 is also defined by wall 44 of a boss 45 in which a hole 60 is formed for enabling attachment of a mounting plate (shown in FIG. 11 and 11A in a manner which will be described hereinafter. The channel 42 may also be formed by webs 47 which extend between the rib 140 and the wall 45 and which have arcuate upper surfaces 47a which match the cylindrical configuration of the mounting rail 16.

The strengthening ribs include the first curved rib 140 and a second curved rib 142 which is spaced outwardly from the first curved rib 140. The ribs 140 and 142 are generally symmetrical about the longitudinal axis of the shell 12. Furthermore, the ribs 140 and 142 generally follow the contour of side wall 150 of slot 26 formed in the shell 12

A third curved rib 146 is provided which extends to nose portion 12a and is integral with the section of the nose portion 12a in which the holes 32 are formed. As can clearly be seen in FIG. 21 boss 45 is provided between the ribs 140 and 142 and the webs 47 extend between wall 44 of the boss 45 and the rib 140. Lateral ribs 152 extend from the third rib 146 and join with the second rib 142 and the first rib 140 and then extend to join with the side wall 150 of the slot 26. The ribs 152 are provided with a arcuate cut out 157 which provide space for the portion 16g of the rail 16 so that those portions do not interfere with rocking or pivotal movement of the shell 12.

Additional lateral ribs 159 extend from the third rib 142 to the boss 45. The ribs 157 and 159 increasing in height from the rib 146 to the wall 150. A lateral rib 161 extends between portions of the third rib 146 at the nose 12a of the shell 12 and a longitudinal rib 162 can extend from lateral rib 161 to the portion of the nose 12a in which the holes of 32 are provided.

The ribs 140 and 142 extend over the hinge portion of the seat which enable the portions 24a and 24b to move relative to one another in the manner described in the above mentioned international application should the seat incorporate that feature. For the sake of illustration this hinge portion is shown between the dotted lines and labelled H in FIG. 4A. As described in the international application hinge portion H is formed integral with the seat and the material from which the shell 12 is moulded.

In the first embodiment of the invention the portion 16h o rail 16 is straight as best shown in FIG. 4. The mounting plate 40 which is shown in FIG. 11 as it would appear if one was looking upwardly from beneath the bicycle seat when the seat is mounted on a bicycle. The view in FIG 11A is of the opposite side to that shown in FIG. 11. The plate 40 has a roof portion 46 and a generally U-shaped wall 48 which terminates in a lower ledge 50. A hole 52 passes through the roof 46. Portion 57 of the root 46 forms an engagement section which will engage over the rail engagement portion 16h so as to sandwich the rail engagement portion 16h between the plate 40 and the shell 12 with rail engagement portion 16h being held between the rows of fingers 42 and 44. The portion 57 is flat and includes a groove 58 for receiving the straight engagement portion 16h of the rail 16.

In order to secure the mounting plate 40 to the shell 12 a rivet 59 passes upwardly through hole 52 and locates in the hole 60 formed in the shell 12. A washer (not shown) may be located between head 61 of the rivet 59 and the plate 40 if desired. The rivet 59 is applied by a conventional tool and the hole 60 may be provide with a step 69 (see FIGS. 13 and 15) behind which a portion 79 of the rivet when the rivet is applied by the tool, can locate so as to secure the rivet in the hole 60 and therefore secure the plate 40 to the boss 45 shown in FIG. 4A. The engagement portion 16h therefore sits in the channel 42 on the webs 47 by engaging upper surfaces 47a of the ribs and also sits in the groove 58 provided in the portion 57 of the plate 40.

Thus, the rail is secured to the shell 12 by engagement of the end 16a of the legs 16b within the holes 30 and sandwiching of the portion 16h between the plate 40 and the shell 12. It will be apparent from a consideration of FIGS. 1 and 5 that the securement within the holes 30 is on the longitudinal axis L of the shell 12 as is the securement of the portion 16h of the rail 16 to the shell 12. In this embodiment of the invention the two end portions 16b are provided on either side of the axis L as best shown in FIG. 2. The width of the plate 40 in the direction of double headed arrow W in FIG. 4 is generally short so that the engagement portion 16h clamped between the plate 40 and the shell 12 generally forms a pivot area on which the shell 12 can rock back and forward in the direction of double headed arrow M in FIG. 4 in a plane perpendicular to the longitudinal axis L (which is into and out of the plane of the paper in FIG. 4 as shown by the dot L marked on FIG. 4). Thus, the portions 24a and 24b of the seat are basically able to move up and down slightly in the direction of double headed arrows P in FIG. 4 as the shell 12 rocks about the longitudinal axis L in the direction of double headed arrow M. This enables the buttock receiving portions 24a and 24b to move up and down slightly relative to the mounting rail 16 during pedaling motion of the bicycle. Thus, as a rider pedals the bicycle and exerts, for example with the left leg, the left buttock may move down slightly thereby pushing the portion 24a downwardly in FIG. 4 and allowing the portion 24b to move upwardly slightly. As the right leg begins to exert pressure the portion 24b can move down with the rocking movement of the seat around the axis L in the direction of double headed arrow M described above. Thus, during the pedaling motion the portions 24a and 24b can move upwardly and downwardly slightly with the shell 12 rocking around the longitudinal axis L as shown by double headed arrow M in FIG. 4. This rocking movement tends to provide a slight movement of the seat which accomodates the muscle movement of the rider so that the seat does not form an unyielding reaction surface against muscle movement of the rider during pedaling motion. The movement of the seat therefore enables the muscle to work better and reduces soreness and fatigue during prolonged pedaling.

When the shell 12 pivots or rocks in the direction of double headed arrow M the engagement of the end portion 161 of the rail 16 in the holes 30 enables a slight rocking motion. Since there are two holes 30 in the embodiment of

FIGS. 1 to 4, the rocking motion is resisted to some extent at the front end of the seat but the fit of the legs 16a, within the holes 30 whilst being relatively tight, is still sufficiently tolerant to allow some rocking or pivotal movement of the shell 12 relative to the rail 16 in the direction of double headed arrow M. In other embodiments the connection of the end portions 16b in the holes 30 may be rigid so that the rocking movement occurs only at the plate 40. Also, in another embodiment the securement of the rail, shell and plate may form a rigid connection with the rocking being accommodated by flexure in the shell material

FIG. 10 shows a second embodiment of the rail 16 which is identical to the embodiment previously described except that the legs 16a are generally coupled together and form a single leg having a single end 16b. In this embodiment a single hole 30 is formed in the nose portion 12a of the shell 12 with the hole having a longitudinal axis which is coincident with the longitudinal axis L of the shell 12. This facilitates greater ability of the rail 16 to rock about the connection formed by the location of the end 16b in the hole 30 because the end 16b and hole 30 are formed exactly on the axis L thereby enabling rocking movement of the shell 12 on a pivot generally formed by the generally cylindrical end 16b of the rail 16.

In a still further embodiment of the invention the rail 16 may have an engagement portion 16h which is slightly curved as shown by the dotted lines 16h′ in FIG. 8. In this embodiment the mounting plate 40 will also have a curved roof section 57′ as shown by the dotted lines in FIG. 11 The curvature of the section 57′ will match the curvature of the engagement portion 16h′. The curved engagement portion 16h′ provides a curved pivot surface on which the shell 12 can pivot to facilitate the pivotal movement in the direction of double headed arrow M previously described. This curved configuration is shown in the cross-sectional view of FIG. 12 which is a view similar to the FIG. 4 except showing the embodiment with the curved portion 16h′ and curved portion 57′ on the mounting plate 40. The curved portion 40 is provided with a groove 58′ for receiving engagement portion 16h.

In other embodiments (not shown), rather than have the ends 16b of the rail L forming the free ends of the rail 16, the legs 16a could be joined by a rounded transition section and the free ends of the rail could be formed at the engagement portion 16h with the free ends generally abutting one another as shown by the dash lines 16q in FIG. 8.

A further embodiment of the invention is shown in FIG. 13 and FIG. 14. In this embodiment the plate 40 is mounted to the shell 12 in exactly the same manner as previously described with the engaging portion 16h of the rail 16 sandwiched between the plate 40 and the shell 12, and, in particular between the groove 58 of the portion 57 of the plate 40 and with the engaging portions 16h locating in channel 42 by resting on the surfaces 47a of the webs 47. However, in this embodiment a resilient pad 100 of semi-cylindrical configuration, as is best shown in FIG. 14, is located on the engagement portion 16h and sits between the engagement portion 16h and the surfaces 47a of the webs 47. The resilient pad can facilitate the rocking movement of the shell 12 relative to the rail 16h which has been previously described or, alternatively, modify that rocking movement by providing some dampening to the movement.

Rather than provide the pad 100 between the surfaces 47a and the engagement portion 16h, the pad could be provided between the engagement portion 16h and the groove 58 of the mounting plate 40. Although in the embodiment shown in FIGS. 13 and 14 the pad 100 is semi-cylindrical in configuration, the pad 100 could be in the form of a cylindrical sleeve which completely engages about the portion 16h and therefore provides as a resilient pad between both the portion 16h and the shell 12 and the portion 16h and the groove 58 of the plate 40.

FIGS. 15 and 16 show a further embodiment in which a resilient pad 102 of generally square shape is located between the plate 40 and the boss 45 which has the hole 60 into which the rivet 59 locates to secure the plate 40 to the shell 12. As shown in FIG. 16, the pad 102 has a central hole 103 for enabling the rivet 59 to pass through the pad 102 and engage in the hole 60 in the manner previously described.

Thus, according to this embodiment of the invention, the pad 100, or the pad 102 provides some resiliency in the securement of the rail 16h to the shell 12 which, by virtu of the resiliency can allow for the rocking movement previously described or, alternatively, can simply modify the rocking movement by dampening the movement or to some extent limiting the movement to provide the desired characteristics of the movement required to suit a particular application of the invention.

In one embodiment of the invention the ends 16b of the leg 16a of the mounting rail 16 could also be provided with resilient pads in the form of resilient sleeves which slip over the end 16b and which locate in the holes 30 together with the ends 16b. The resilient pad in this embodiment can function in a similar manner to that described above to facilitate or dampen movement of the shell relative to the ends 16b if desired.

FIG. 17 to 20 show a further embodiment of the invention in which the shell 12 is provided with a cavity 120 in nose portion 12a. In this embodiment cavity 12a can be formed from a single recess or hole formed in the nose portion 12a rather than two separate holes as in the previously described embodiment of FIG. 1. In this embodiment, the mounting rail 16 has a nose section 16′ which is formed by a rounded part of the nose section 15 which is received in the cavity 120.

In one embodiment of the invention, the cavity 120 can be a tight fit around the nose portion 16′ of the rail 16 or, alternatively, as shown by dotted lines in FIG. 19 can be slightly larger than the nose portion 16′ and have an arcuate surface to allow for some slight rocking movement of the nose portion 12a of the shell 12 relative to the rail 16.

The rail 16 has a pair of free ends 16″ which are formed at the rear part of the rail in this embodiment. The portions 16″ are received in sockets 124 which are formed integrally with the shell 12 and which have open ends 126 which face towards outside edges of the shell. In another embodiment (not shown) the sockets could have openings which face towards one another and are provided on inner ends of the sockets 124.

As best shown in FIG. 20 the sockets 124 are somewhat larger than the free ends 16″ of the rail 16 so as to enable rocking movement of the seat in the manner previously described. The sockets 124 may include resilient pads 130 and 132 as shown in FIG. 20. The pad 130 is arranged above the respective end 16″ and the pad 132 below the respective end 16″. Thus, when the shell 12 rocks back and forward in the direction of double headed arrow P the resilient pads 130 and 132 will be compressed between portions 133 and 131 of the sockets 124 and the respective ends 16″ of the rail 16. In alternative embodiments, the resilient pads 130 and 132 can be omitted and the sockets may include an air space facilitating the rocking movement.

Since modifications within the spirit and scope of the invention may readily be effected by persons skilled within the art, it is to be understood that this invention is not limited to the particular embodiment described by way of example hereinabove.

1. A bicycle seat including;
a shell having a seat portion for enabling a user to sit on the seat and pedal a bicycle;
a mounting means for mounting the seat to a bicycle; and
first securing means for securing the mounting means to the shell to allow the shell to rock relative to the mounting means in a plane substantially perpendicular to the longitudinal axis of the bicycle when the seat is mounted on the bicycle.

2. A bicycle seat including;
a shell having a front nose portion and rear seat portion, the shell having a longitudinal axis through the nose portion and the seat portion;
a mounting rail for mounting the seat to a bicycle;
first securing means for securing the rail to the seat portion of the shell substantially on the longitudinal axis of the shell;
second securing means for securing the rail to the nose portion of the shell substantially on the longitudinal axis of the shell; and
wherein the first securing means allows the shell to rock relative to the rail in a plane substantially perpendicular to the axis of the shell.

3. The seat of claim 1 wherein the first securing means includes a mounting plate for sandwiching a portion of the rail between the plate and the shell, wherein the mounting plate has a rail receiving portion which is curved to define a curved pivot surface, said portion of said rail also being curved in a manner corresponding to the curvature of the mounting plate, the curved portion of the rail providing a curved surface on which the shell can easily rock or pivot to facilitate a rocking movement.

4-6. (canceled)

7. The seat of claim 2 wherein the first securing means includes a mounting plate for sandwiching a portion of the rail between the plate and the shell, wherein the mounting plate has a rail receiving portion which is curved to define a curved pivot surface, said portion of said rail also being curved in a manner corresponding to the curvature of the mounting plate, the curved portion of the rail providing a curved surface on which the shell can easily rock or pivot to facilitate a rocking movement.

8. The seat of claim 2 wherein said second securing means comprises at least one hole in said shell into which a second portion of said rail projects.

9. The seat of claim 8 wherein said at least one hole comprises a single hole is provided which has a longitudinal axis coincident with the longitudinal axis of the shell, said second portion of the rail being comprised by two legs of the rail which are adjacent one another and which insert into said hole.

10. The seat of claim 8 wherein said at least one hole comprises two holes are provided in the shell, the holes being adjacent the longitudinal axis of the shell with one hole on each side of the axis, the rail having two legs which are spaced apart from one another which form said second portion of the rail, the legs of the rail being inserted into said holes.

11. The seat of claim 1 wherein a resilient member is disposed between the first securing means and the shell.

12-13. (canceled)

14. The seat of claim 2 wherein the first securing means may comprises a pair of spaced apart sockets formed in the shell for receiving free ends of the rail at a rear portion of the rail.

15. The seat of claim 14 wherein the sockets include resilient pads for facilitating rocking movement of the shell relative to the free ends of the rail.

16-24. (canceled)

25. The seat of claim 26 wherein the rib structure allows the shell to spring or flex.

26. A bicycle seat including;
a shell having an upper surface upon which a user sits to pedal a bicycle;
an underneath surface;
a rib structure formed on the underneath surface, the rib structure including;
a first curved rib;
a second curved rib spaced from the second curved rib; and
a plurality of lateral ribs interconnecting the first and second curved ribs.

27. The seat of claim 26 wherein the bicycle seat includes a slot in a rear portion of the seat and the slot includes a wall portion which extends downwardly from the bottom surface of the shell, the lateral ribs extending to and joining the said wall portion.

28. The seat of claim 26 wherein a third curved rib is provided, the third curved rib being spaced from the second curved rib and the lateral ribs joining the first rib, the second curved rib and the third curved rib.

29. The seat of claim 26 wherein a boss is formed between the first curved rib and the second curved rib, the boss having a hole for receiving a mounting fixture for facilitating mounting of a rail to the shell, the boss having an end wall, a plurality of curved webs extending between the end wall and the first curved rib which, with the end wall and the first curved rib define a channel for receiving a part of the mounting rail, and wherein further lateral ribs extend from the boss and connect with the second curved rib.

30. The seat of claim 2 wherein a resilient member is disposed between the first and second securing means.
